(19) United States
(12) Patent Application Publication
(10) Pub. No.: US 2015/0367388 A1
(43) Pub. Date: Dec. 24, 2015

(54) PLANAR DUST-STICKING ROLLER

(71) Applicant: Shenzhen China Star Optoelectronics Technology Co., Ltd., Shenzhen, Guangdong (CN)

(72) Inventor: Song WANG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 14/384,455

(22) PCT Filed: Jul. 14, 2014
(86) PCT No.: PCT/CN2014/082127

§ 371 Date: Sep. 11, 2014

(30) Foreign Application Priority Data
Jun. 23, 2014 (CN) 201410284298.3

(51) Int. Cl. B08B 7/00

(52) U.S. Cl. CPC B08B 7/0028

(57) ABSTRACT

The present invention provides a planar dust-sticking roller. The planar dust-sticking roller includes: a core reel (1) and a dust-sticking adhesive tape (3). The dust-sticking adhesive tape (3) is wrapped, in an outward exposing manner, around an outer circumference of the core reel (1). The outer circumference of the core reel (1) has at least one flat planar surface (11). The core reel (1) has a cross section having an outer contour that is a regular polygon. The number of the flat planar surfaces (11) is at least five. A curved chamfer (15) is formed at a connection between the flat planar surfaces (11). The planar dust-sticking roller is capable of removing a flake-like foreign object having a relatively large size, enhancing the cleansing performance of the dust-sticking roller, and improving the cleansing effect.

### BACKGROUND OF THE INVENTION

1. Field of the Invention

The present invention relates to a cleansing tool, and in particular to a planar dust-sticking roller.

2. The Related Arts

A dust-sticking roller is applicable to cleansing a surface of a wiring board, a PCB (Printed Circuit Board), an LCD (Liquid Crystal Display), a light guide plate, an electronic semiconductor, and film precision printing and can be used to cleansing various planar surfaces, such as a glass panel, a laminated steel plate, and a working table. A dust-sticking roller comprises multiple layers of dust-sticking tape wrapped around an outer circumferential surface of a core reel and, when used, can be rolled on a surface to be cleansed in a way similar to painting a wall to efficiently adhere and remove all sorts of tiny particles, debris, filaments, and dusts to accomplish the purpose of cleansing without causing secondary contamination of the surface to be cleansed that often results from the conventional ways of cleansing, such as water washing, wiping cloth, and cleansing brushes.

Referring to FIG. 1, a conventional dust-sticking roller is generally cylindrical and comprises a cylindrical core reel 100 and multiple layers of dust-sticking tape 300 that are wrapped, in an outward exposing manner, around an outer circumferential surface of the core reel 100. During use, such a cylindrical dust-sticking roller provides a relationship of linear contact with a surface to be cleansed. In other words, the contact area is relatively small. When the dust-sticking roller encounters a flake-like foreign object 200 having a relatively large size, since the dust-sticking roller 200 applies a downward action force N and since the foreign object 200 may have some kind of hardness, the contact area between the dust-sticking roller 200 would be small and thus the adhesion to the foreign object 200 is correspondingly small, making it possible for the relatively large flake-like foreign object 200 to get readily falling. In other words, no cleansing can be achieved for such a relatively large flake-like foreign object 200. This affects the overall cleansing effect of the dust-sticking roller.

### SUMMARY OF THE INVENTION

An object of the present invention is to provide a planar dust-sticking roller, which overcomes the drawbacks of a conventional cylindrical dust-sticking roller and can remove a flake-like foreign object having a relatively large size so as to enhance the cleaning performance of the dust-sticking roller and improve the cleansing effect.

To achieve the above object, the present invention provides a planar dust-sticking roller, which comprises a core reel, the core reel having an outer circumference that comprises at least one flat planar surface, and further comprises a dust-sticking adhesive tape, which is wrapped, in an outward exposing manner, around the outer circumference of the core reel.

The core reel has a cross section having an outer contour that is polygonal.

The outer contour of the cross section of the core reel is one of a regular pentagon, a regular hexagon, and a regular octagon.

The core reel comprises a coupling hole formed therein and coupled to a handle, so that the core reel is rotatable with a coupling section of the handle that is coupled thereto.

The coupling hole is circular.

The outer circumference of the core reel comprises a plurality of flat planar surface and a curved chamfer is formed at a connection two adjacent ones of the flat planar surfaces.

The number of the flat planar surfaces is at least five.

The plurality of flat planar surfaces is of an identical size.

The present invention also provides a planar dust-sticking roller, which comprises a core reel, the core reel having an outer circumference that comprises at least one flat planar surface, and further comprises a dust-sticking adhesive tape, which is wrapped, in an outward exposing manner, around the outer circumference of the core reel;
the core reel having a cross section having an outer contour that is polygonal;
the core reel comprising a coupling hole formed therein and coupled to a handle, so that the core reel is rotatable with a coupling section of the handle that is coupled thereto;
the coupling hole being circular;
the outer circumference of the core reel comprising a plurality of flat planar surface, a curved chamfer being formed at a connection two adjacent ones of the flat planar surfaces;
the number of the flat planar surfaces being at least five;
the plurality of flat planar surfaces being of an identical size.

The efficacy of the present invention is that the present invention provides a planar dust-sticking roller, which comprises a core reel having a cross section of which an outer contour is formed as a regular polygon so that an outer circumference of the core reel comprises a plurality of flat planar surfaces, allowing the planar dust-sticking roller to form a relationship of surface contact with a surface to be cleansed during the use thereof so as to increase the adhesion force that the planar dust-sticking roller is applied for a flake-like foreign object having a relatively large size, reduce the risk that the foreign object get falling, thus capable of removing a flake-like foreign object of a relatively large size to enhance the cleansing performance of the planar dust-sticking roller and improve the cleansing effect.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a schematic view illustrating an operation process of a conventional cylindrical dust-sticking roller;

FIG. 2 is a schematic view showing a planar dust-sticking roller according to a first embodiment of the present invention;

FIG. 3 is a schematic view showing a planar dust-sticking roller according to a second embodiment of the present invention;

FIG. 4 is a schematic view showing a planar dust-sticking roller according to a third embodiment of the present invention;

FIG. 5 is a schematic view illustrating an operation process of a planar dust-sticking roller according to the present invention;

FIG. 6 is a schematic view illustrating a modification of the planar dust-sticking roller according to the first embodiment of the present invention;

FIG. 7 is a schematic view illustrating a modification of the planar dust-sticking roller according to the second embodiment of the present invention; and

FIG. 8 is a schematic view illustrating a modification of the planar dust-sticking roller according to the third embodiment of the present invention.

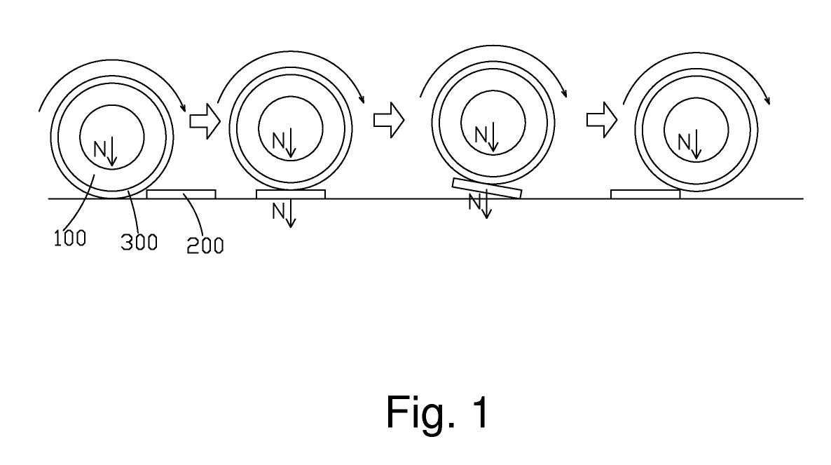

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

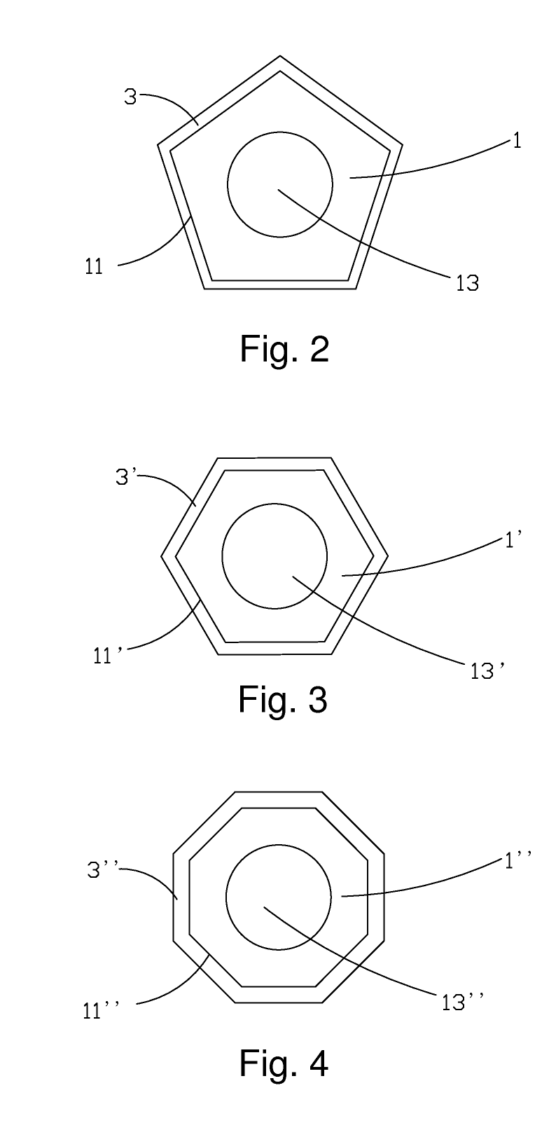

Referring to FIG. 2, a schematic view is given to show a planar dust-sticking roller according to a first embodiment of the present invention. The planar dust-sticking roller comprises a core reel 1 and a dust-sticking adhesive tape 3. The dust-sticking adhesive tape 3 is wrapped, in an outward exposing manner, around an outer circumference of the core reel 1. The outer circumference of the core reel 1 comprises at least one flat planar surface 11. The core reel 1 has a cross section having a polygonal outer contour. Preferably, the outer contour of the cross section of the core reel 1 is a regular polygon so that the outer circumference of the core reel 1 comprises a plurality of flat planar surfaces 11 and the plurality of flat planar surfaces 11 are of an identical size. In the first embodiment, the outer contour of the cross section of the core reel 1 is a regular pentagon and the outer circumference of the core reel 1 comprises five flat planar surfaces 11.

The core reel 1 further comprises a coupling hole 13. Preferably, the coupling hole 13 is a circular hole for coupling with a handle (not shown). The core reel 1 is rotatable with a coupling section of the handle that is coupled thereto.

The dust-sticking adhesive tape 3 may comprise multiple layers to adhere and thus remove foreign objects to be removed, such as particles, debris, filaments, and dusts. When an outer layer of the dust-sticking adhesive tape 3 is completely filled with the foreign object or loses adhesion, the layer of the dust-sticking adhesive tape 3 can be peeled off to expose a next new layer of the dust-sticking adhesive tape 3 for subsequent cleansing operations.

Referring to FIG. 3, a schematic view is given to show a planar dust-sticking roller according to a second embodiment of the present invention. In the second embodiment, the outer contour of the cross section of the core reel 1′ is a regular hexagon and the outer circumference of the core reel 1′ comprises six flat planar surfaces 11′.

Referring to FIG. 4, a schematic view is given to show a planar dust-sticking roller according to a third embodiment of the present invention. In the third embodiment, the outer contour of the cross section of the core reel 1″ is a regular octagon and the outer circumference of the core reel 1″ comprises eight flat planar surfaces 11″.

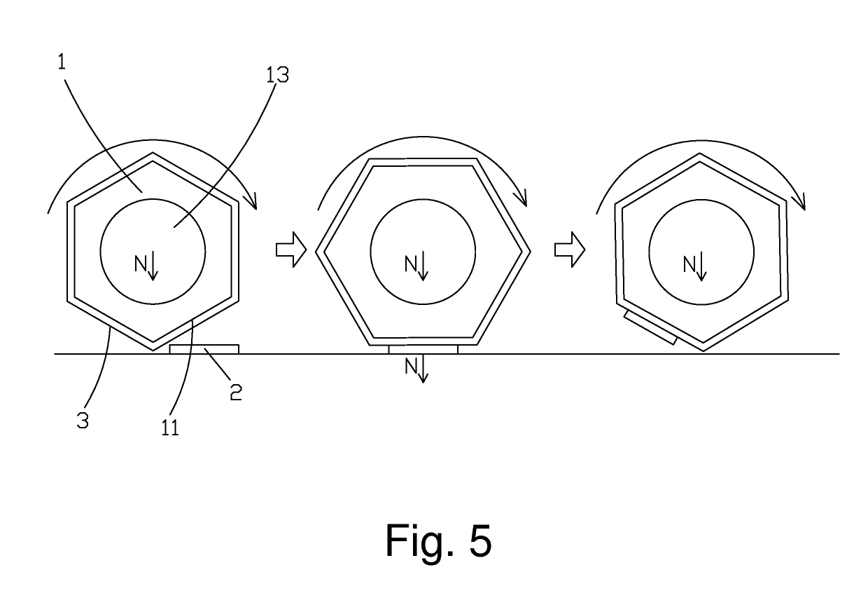

Referring to FIG. 5, a schematic view is given to illustrate an operation process of a planar dust-sticking roller according to the present invention. The planar dust-sticking roller is driven to roll on a surface to be cleansed. Since the outer contour of the cross section of the core reel 1 is a regular polygon and the outer circumference of the core reel 1 comprises a plurality of flat planar surfaces 11, a relationship of surface contact is established with respect to the surface to be cleansed. When the planar dust-sticking roller contacts a flake-like foreign object 2 having a relatively large size, the dust-sticking adhesive tape 3 provides a sticking surface having a large area for adhering the foreign object 2 and thus, the adhesive force applied to the foreign object 2 is also enlarged to be sufficient to adhere the foreign object 2 on a surface of the dust-sticking adhesive tape 3 ad to reduce the risk that the foreign object 2 gets falling thereby achieving an effect of removing a large-sized flake-like foreign object 2 and enhancing the overall cleansing performance of the planar dust-sticking roller.

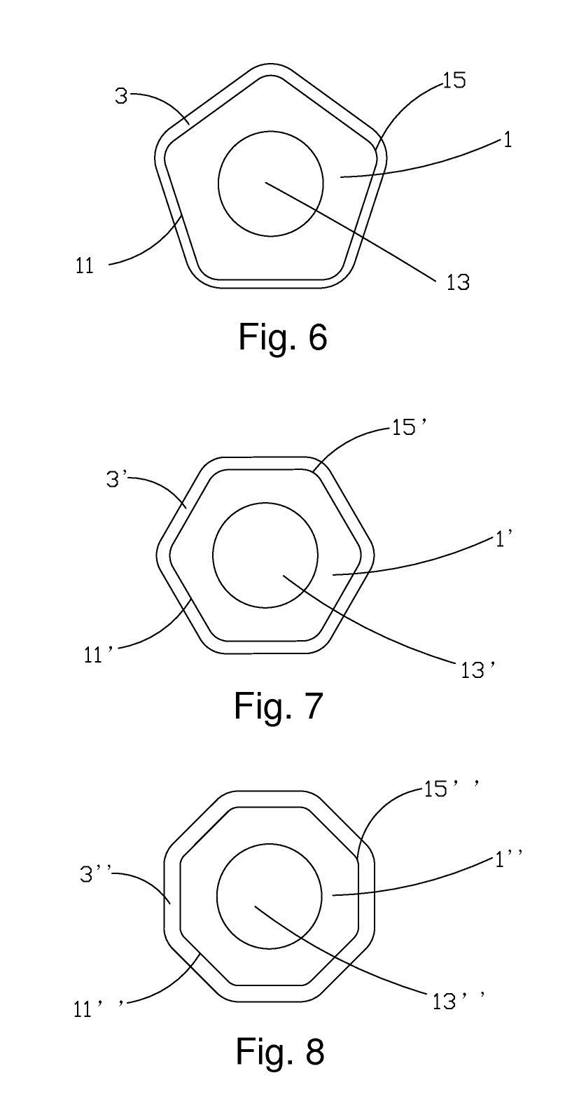

Further, to prevent a linear contact from being established between an intersection line between two adjacent flat planar surfaces 11 of the outer circumference of the core reel 1 of the planar dust-sticking roller and the surface to be cleansed and also to reduce wear occurring on the planar dust-sticking roller and the surface to be cleansed, modifications are further made on the structure of the core reel 1 of the planar dust-sticking roller. As shown in FIG. 6, a curved chamfer 15 is formed at the connection between two adjacent flat planar surfaces 11 of the outer circumference of the core reel 1 of the planar dust-sticking roller of the first embodiment in order to increase the contact area thereof with the surface to be cleansed.

As shown in FIG. 7, a curved chamfer 15′ is formed at the connection between two adjacent flat planar surfaces 11′ of the outer circumference of the core reel 1′ of the planar dust-sticking roller of the second embodiment in order to increase the contact area thereof with the surface to be cleansed.

As shown in FIG. 8, a curved chamfer 15″ is formed at the connection between two adjacent flat planar surfaces 11″ of the outer circumference of the core reel 1″ of the planar dust-sticking roller of the third embodiment in order to increase the contact area thereof with the surface to be cleansed.

In summary, the present invention provides a planar dust-sticking roller, which comprises a core reel having a cross section of which an outer contour is formed as a regular polygon so that an outer circumference of the core reel comprises a plurality of flat planar surfaces, allowing the planar dust-sticking roller to form a relationship of surface contact with a surface to be cleansed during the use thereof so as to increase the adhesion force that the planar dust-sticking roller is applied for a flake-like foreign object having a relatively large size, reduce the risk that the foreign object get falling, thus capable of removing a flake-like foreign object of a relatively large size to enhance the cleansing performance of the planar dust-sticking roller and improve the cleansing effect.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A planar dust-sticking roller, comprising a core reel, the core reel having an outer circumference that comprises at least one flat planar surface.

2. The planar dust-sticking roller as claimed in claim 1 further comprising a dust-sticking adhesive tape, which is wrapped, in an outward exposing manner, around the outer circumference of the core reel.

3. The planar dust-sticking roller as claimed in claim 1, wherein the core reel has a cross section having an outer contour that is polygonal.

4. The planar dust-sticking roller as claimed in claim 3, wherein the outer contour of the cross section of the core reel is one of a regular pentagon, a regular hexagon, and a regular octagon.

5. The planar dust-sticking roller as claimed in claim 1, wherein the core reel comprises a coupling hole formed therein and adapted to couple to a handle, so that the core reel is rotatable with a coupling section of the handle that is coupled thereto.

6. The planar dust-sticking roller as claimed in claim 5, wherein the coupling hole is circular.

7. The planar dust-sticking roller as claimed in claim 1, wherein the outer circumference of the core reel comprises a plurality of flat planar surface and a curved chamfer is formed at a connection two adjacent ones of the flat planar surfaces.

8. The planar dust-sticking roller as claimed in claim 7, wherein the number of the flat planar surfaces is at least five.

9. The planar dust-sticking roller as claimed in claim 8, wherein the plurality of flat planar surfaces is of an identical size.

10. A planar dust-sticking roller, comprising a core reel, the core reel having an outer circumference that comprises at least one flat planar surface;
the planar dust-sticking roller further comprising a dust-sticking adhesive tape, which is wrapped, in an outward exposing manner, around the outer circumference of the core reel;
wherein the core reel has a cross section having an outer contour that is polygonal;
wherein the core reel comprises a coupling hole formed therein and adapted to couple to a handle, so that the core reel is rotatable with a coupling section of the handle that is coupled thereto;
wherein the coupling hole is circular;
wherein the outer circumference of the core reel comprises a plurality of flat planar surface and a curved chamfer is formed at a connection two adjacent ones of the flat planar surfaces;
wherein the number of the flat planar surfaces is at least five; and
wherein the plurality of flat planar surfaces is of an identical size.
